(19) United States
(12) Patent Application Publication
(10) Pub. No.: US 2022/0097006 A1
(43) Pub. Date: Mar. 31, 2022

(54) BIOFOULING REMOVAL AND MITIGATION USING DIRECT ELECTRICAL SHOCK TECHNOLOGY

(71) Applicant: KING ABDULLAH UNIVERSITY OF SCIENCE AND TECHNOLOGY, Thuwal (SA)

(72) Inventors: Adnan QAMAR, Thuwal (SA); Sarah KERDI, Thuwal (SA); Johannes VROUWENVELDER, Thuwal (SA); Noreddine GHAFFOUR, Thuwal (SA)

(21) Appl. No.: 17/428,717

(22) PCT Filed: Feb. 12, 2020
(86) PCT No.: PCT/IB2020/051140

§ 371 Date: Aug. 5, 2021

Related U.S. Application Data
(60) Provisional application No. 62/804,855, filed on Feb. 13, 2019.

(51) Int. Cl. B01D 65/02; B01D 63/10; C02F 1/46; C02F 1/467; C02F 1/461

(52) U.S. Cl. CPC B01D 65/02; B01D 63/10; C02F 1/4602; C02F 2103/08; C02F 1/46109; B01D 2313/143; C02F 2209/03; C02F 1/4674

(57) ABSTRACT

A biofouling/biofilm removal system includes a filtration module configured to separate a permeate from a feed; a first inert electrode placed at an inlet of the filtration module; a second inert electrode placed at an outlet of the filtration module; and a power source configured to apply a current between the first and second electrodes. The inlet is configured to receive the feed and the outlet is configured to discard a concentrate, and the current applied between the first and second electrodes initiates electrochemical reactions inside the feed and along a biofilm formed in the filtration module, but not into the permeate.

### CROSS-REFERENCE TO RELATED APPLICATIONS

This application claims priority to U.S. Provisional Patent Application No. 62/804,855, filed on Feb. 13, 2019, entitled “BIOFOULING REMOVAL AND MITIGATION USING DIRECT ELECTRICAL SHOCK TECHNOLOGY (DEST) IN WATER TREATMENT SYSTEMS,” the disclosure of which is incorporated herein by reference in its entirety.

### BACKGROUND

### Technical Field

Embodiments of the subject matter disclosed herein generally relate to a system and method for removing biofouling/biofilm, and more particularly, to a system that uses direct electrical shock technology to control/remove biofouling/biofilm from a filtration membrane module.

### Discussion of the Background

The shortage of freshwater supply and deprivation of the oil resources across the globe augment the development of new cost-effective desalination technologies. Various membrane filtration processes are used today for processing saline water (e.g., seawater, brackish water, etc.) or a feed containing electrolytes (salts) and these processes include, but are not limited to, microfiltration (MF), ultrafiltration (UF), nanofiltration (NF), reverse osmosis (RO), membrane distillation (MD), etc. A typical membrane filtration system 100 is illustrated in FIG. 1, and it includes a membrane filtration unit 110 that is fluidly connected to a feed reservoir 130 and a permeate reservoir 140. The feed reservoir 130 holds the feed 132 (e.g., saline water), which is pumped with a pump 134 into a feed part 114 of the filtration unit 110. The permeate reservoir 140 holds the permeate 142 (e.g., fresh water), which is collected from the permeate part 116 of the filtration unit 110. A membrane 112 is placed between the feed part 114 and the permeate part 116, so that the fluid feed 132 cannot pass into the permeate part 116. The membrane 112 is so selected that only water 138 from the feed part 114 passes into the permeate part 116 as permeate 142. The permeate 142 is then collected at the permeate tank 140. A feed spacer 150 may be placed next to the membrane 112, inside the feed part 114, for promoting the filtration process.

One of the major concerns affecting the performance of the membrane filtration system discussed above and other filtration systems in general is the deposition of foulants on the membrane surface leading to reversible and irreversible fouling. Irreversible fouling has a severe impact on the lifetime of the membrane and overall life of the filtration module. Irreversible fouling results in permeate flux decline and increase of the pressure drop.

Several types of membrane fouling are encountered in the filtration process and they include inorganic, organic, and bacterial fouling, all of them referred to as biofouling. Biofouling on the membrane surface presents a serious problem as the bacteria, once attached on the membrane surface, excretes extracellular polymeric substances (EPS), which over time form a protective matrix for embedded and growing microorganisms, also known as the biofilm. FIG. 2 illustrates this problem by showing the biofilm 202 formed on top of the membrane 112. Various bacterial cells 204 use the biofilm 202 as a natural habitat, further contributing to the biofouling of the membrane. Note that a biofilm is also considered to be biofouling.

Under these circumstances, the feed 210, that advances along direction 212 at the top of the membrane 112, is prevented from reaching the top surface of the membrane, thus, reducing the filtration capabilities of the membrane. Moreover, the spreading of the bacterial cells 204 throughout the entire filtration system 200 is promoted by the presence of the biofilm 202. Therefore, biofouling prevention and control is a challenge for optimal membrane filtration performance.

Methods to control biofouling, including on membrane surfaces, have been proposed in the past with limited success. Water pretreatment, such as capillary filtration, flocculation, phosphate limitation, has been shown to have high effectiveness in reducing the extent of microbial growth on the membrane surfaces. Biological methodologies, such as the use of bacteriophage, quorum sensors inhibitors, and the addition of nitric oxide (NO) donors assist in reducing bacterial attachment, which might result in delaying the biofilm formation.

In some recent studies, membrane materials were modified to intrinsically change the physical-chemical properties towards antimicrobial tendency. The manipulation in hydrodynamic conditions is also utilized to control the fluid shear and flow turbulence to mitigate biofouling using special design of feed spacers. Apart from that, there are various physical processes that are often utilized in industry to achieve membrane cleaning such as hydraulic flushing, backwashing, pneumatic air (gas) bubbling, air (gas) sparging and ultrasound approaches.

Chemical cleaning of membranes is another approach that has been pursued aiming to inactivate and control/remove the biofilms. Chlorine derivatives including gas chlorine, hypochlorite, and chloramine remain the most commonly used disinfectants, widely employed in the industrial water treatment applications. Acids (e.g., HCl, H₂SO₄, and HNO₃), alkalines (e.g., KOH, NaOH), surfactants, and oxidants/disinfectants agents (e.g., NaOCl, H₂O₂) are the common chemicals used for bacterial inhibition and removal. These traditional physical and chemical techniques have inherent drawbacks which hamper their application such as the lack of cleaning efficiency for irreversible foulants, the high operating cost, the production of toxic chemical by-products, the reduced lifetime of the membrane, and the limitation of the industrial scale application.

Pure biological studies have shown that an electric field passed in a conductive solution could have a lethal impact on the microorganisms 204, but not on the biofilm 202. These studies have shown that a fully microbial inactivation in natural seawater can be effectively achieved in less than a second time frame by applying a low-ampere current (e.g., 1-2 Amps). The effect of the external electric field for mitigating the membrane biofouling has been investigated [1] to [5]. Electrokinetic methods were previously investigated by applying a direct or alternative current perpendicularly to the membrane, as illustrated in FIG. 2. In these studies, electrodes 220 and 230 were placed at the feed side 112A of the membrane 112 and at the permeate side 112B of the membrane [1], respectively, or an electro-membrane was used as the other electrode [4]. Then, the electrodes were connected to a power source 222 and a direct current was applied to the electrodes. A gel type foulant layer was removed successfully towards the electrode having an opposite charge as the gel foulant, through electrophoresis phenomena. In all these studies, the electrical field E formed between the electrodes is perpendicular to the surface of the membrane 112, and extends from the feed to the permeate. These studies also demonstrated a water flux enhancement through the membrane 112 due to the electro-osmosis phenomena as the electrodes 220 and 230 are placed on both sides of the membrane [1] to [5].

The use of electro-conductive feed spacers and membranes is actively pursued to mitigate microbial attachment. In these approaches, the electrons find a conductive path either along the spacer or along the part of the membrane that is conductive. However, the electrons find a more resistive path through the dielectric feed solution (generally seawater) and therefore, these electrons travel through the spacer/membrane only. As a result, in these approaches, only the bacterial attachment on the spacer or the conductive part of the membrane is mitigated. However, the bacteria still have the potential to attach themselves either onto the spacer or the membrane surface, which results in growing the biofilm.

Thus, there is a need for an efficient method and system for removing the biofilm in the membrane modules.

### BRIEF SUMMARY OF THE INVENTION

According to an embodiment, there is a biofouling removal system that includes a filtration module configured to separate a permeate from a feed, a first inert electrode placed at an inlet of the filtration module, a second inert electrode placed at an outlet of the filtration module, and a power source configured to apply a current between the first and second electrodes. The inlet is configured to receive the feed and the outlet is configured to discard a concentrate. The current applied between the first and second electrodes initiates electrochemical reactions inside the feed and along a biofilm formed in the filtration module, but not into the permeate.

According to another embodiment, there is a filtration module configured to separate a permeate from a feed to generate a concentrate. The filtration module includes a membrane that separates the permeate from the feed, an inlet configured to receive the feed, an outlet configured to discharge the concentrate, a permeate outlet configured to release the permeate, a first electrode placed at the inlet of the filtration module, and a second electrode placed at the outlet of the filtration module. A current is applied between the first and second electrodes in the feed and concentrate, but not in the permeate.

According to yet another embodiment, there is a method for removing biofouling from a membrane. The method includes separating a permeate from a feed with a filtration module that includes a membrane, sensing that a pressure difference across the filtration module is above a given threshold, and applying an electrical current between first and second electrodes, placed along the filtration module, to control the biofouling/biofilm. The electrical current is applied between the first and second electrodes in the feed and a subsequent concentrate, but not in the permeate.

### BRIEF DESCRIPTION OF THE DRAWINGS

For a more complete understanding of the present invention, reference is now made to the following descriptions taken in conjunction with the accompanying drawings, in which:

FIG. 1 is a schematic diagram of a membrane filtration system;

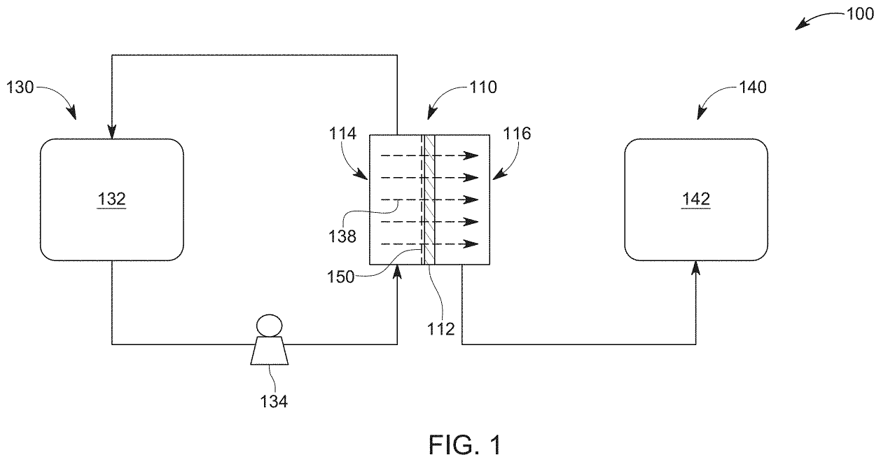

FIG. 2 illustrates the formation of biofilm/biofouling on a membrane in a membrane filtration system;

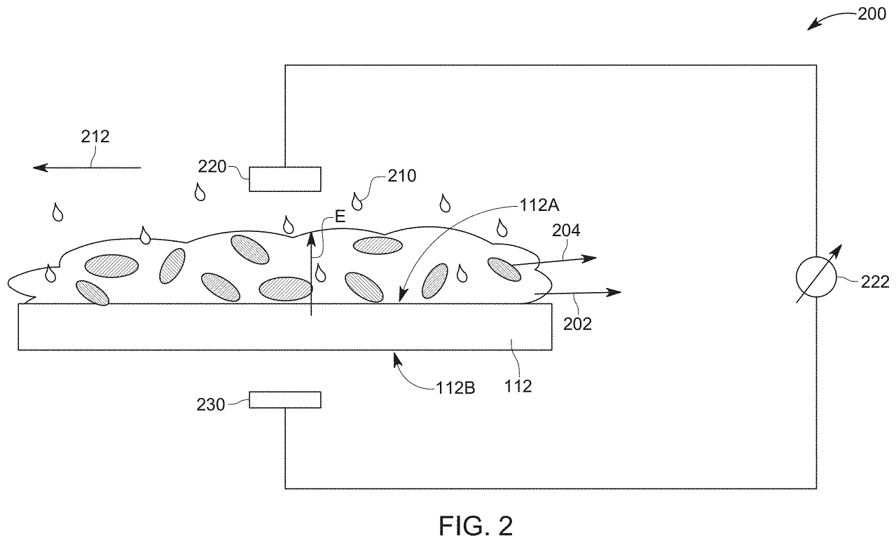

FIG. 3 illustrates a novel biofouling/biofilm removal system that removes the biofouling/biofilm from a membrane;

FIGS. 4A and 4B illustrate the process of removing the biofouling/biofilm from the surface of a membrane;

FIG. 5 illustrates a spiral wound membrane module that is used in saline water desalination;

FIG. 6 illustrates a biofouling/biofilm removal system that uses an electrical field in a feed for removing the biofouling/biofilm; and

FIG. 7 is a flowchart of a method for separating the biofouling/biofilm from a membrane of a filtration module.

### DETAILED DESCRIPTION OF THE INVENTION

The following description of the embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to a single filtration module. However, the embodiments to be discussed next are not limited to one module, but may be applied to plural filtration modules (MF, UF, NF, RO, FO, MD, etc.) or to other units that use a membrane that may experience membrane biofouling/biofilm.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

According to an embodiment, a novel technology and system are provided that aim to effectively remove/mitigate biofouling/biofilm from membrane locations which are submerged or in contact with an electrically conductive fluid. An electrically conductive fluid is considered to be the saline water, e.g., the saltwater, but not the fresh water. Therefore, an appropriate application to this novel technology is in membrane filtration systems e.g., microfiltration (MF), Ultrafiltration (UF), Nanofiltration (NF), Reverse Osmosis (RO), Forward Osmosis (FO), and Membrane Distillation (MD), cooling towers, pipelines, reservoirs, and reactors that process the electrically conductive fluid and are encountered in several process industries. This novel technology is based on electrically shocking the biofilm in its environment through a low-amplitude direct current ranging between 10-500 mA. The current is provided, by the arrangement of the electrodes, to flow along a surface of the membrane, only in the feed side, and not from the permeate side to the feed side as traditionally performed. The current can be increased, depending on the available resistance between the electrodes through the electrically conductive fluid. A higher range of current amplitude could be as well applied in this technology. The dosage of electrical current can be continuous or intermittent for biofouling control, and its amplitude depends on the process design and operational parameters (e.g., thickness of biofilm, electrical conductivity of the surrounding fluid, distance between the electrodes, etc.).

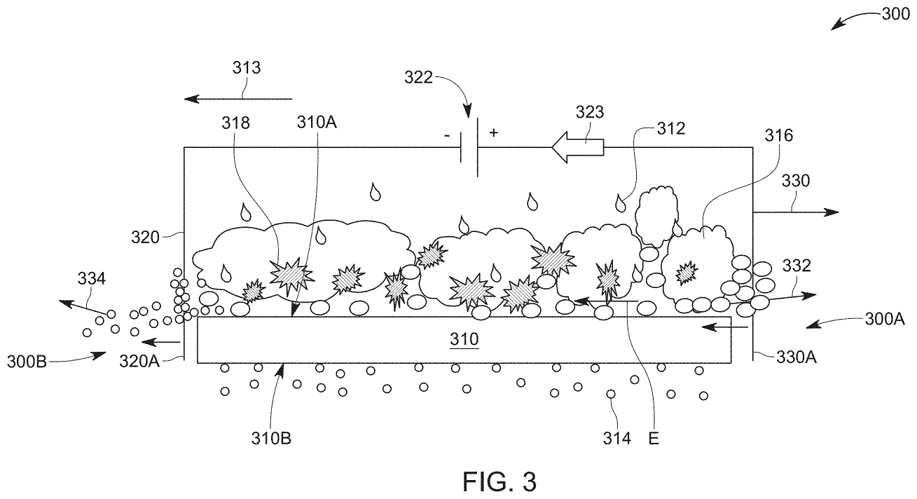

The present technology is ideally suitable for saline water desalination and reuse application among others. Seawater, which is an example of saline water, naturally contains salts and therefore, is an electrically conductive fluid. An embodiment of this technology is illustrated in FIG. 3, which schematically illustrates a membrane filtration system 300 in which saline water is utilized as the feed. A simple membrane 310 is shown having a feed side 310A and a permeate side 3108, with the feed side being in contact with the saline water 312 while the permeate side is in contact with the fresh water 314. FIG. 3 further shows a biofilm 316 and various bacteria 318 formed on the feed side of the membrane.

At the location at which the biofilm 316 needs to be removed, two electrodes 320 and 330 are added. The two electrodes 320 and 330 are connected to a power source 322, for example, a DC power source. However, the power source 322 may be an AC power source or any other type of power source that is capable to produce AC or DC current. In one application, the two electrodes 320 and 330 are placed to be located exclusively on the feed side of the membrane, so that the tips 320A and 330A of the two electrodes 320 and 330 are completely submerged in the saline water 312. In the same application, the two electrodes are hanging in the saline water, i.e., they are not attached to the membrane or a spacer or any other structure defining the membrane module. In this embodiment, the tips 320A and 330A of the two electrodes 320 and 330 are floating free in the saline water, i.e., they are not in contact with any solid part of the system 300.

While the feed 312 is flowing as indicating by arrow 313, the electrodes are connected to the DC power source 322 so that the upstream electrode 330 is positively charged while the downstream electrode 320 is negatively charged. The terms “upstream” and “downstream” are used herein in relation to the flow direction 313 of the feed. Thus, the term “upstream” means a position closer to the source of the feed (saline water) and the term “downstream” means a position farther away from the same source.

In one embodiment, the electrodes 320 and 330 are selected to be made of an inert material, e.g., platinum, graphite, gold. When a direct current 323 is applied in the conductive environment of the saline water, such as seawater 312, electrochemical reactions start at the two tips of the electrodes and these reactions are described by the following chemical reactions:

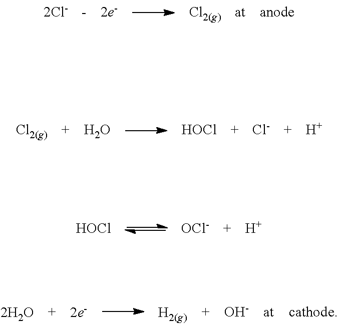

where Cl is chlorine, H is hydrogen, O is oxygen, e is an electron, and the symbol “g” indicates a gas phase.

The above electrochemical reactions take place only because the first and second electrodes 320 and 330 are placed in the same electrically conductive substance (e.g., seawater) and only because the tips of both of them are not in contact with the membrane or a spacer or any other conductive solid element of the system 300. The electrochemical reactions produce gas bubbles of chlorine and hydrogen in a very controlled manner and the amount of gas bubbles can be increased or decreased by controlling the current 323's amplitude.

In this embodiment, the upstream electrode 330 is wired to the power source 322 to be positively biased so that the Cl microbubbles 332 are formed upstream and the H microbubbles 334 are formed downstream relative to the location of the membrane 310. This specific wiring of the electrodes is advantageous because it was observed that the Cl microbubbles 332 more effectively dislodge the biofilm 316 from the feed side 310A of the membrane 310. Thus, in this embodiment, the H microbubbles 334 are blown away from the membrane due to the feed flow direction 313 while the Cl microbubbles 332 are blown into the biofilm 316 and the bacteria 318, along the surface of the membrane. The positioning of the electrodes 320 and 330 or their wiring to the power source can be switched according to the application.

However, whichever electrode is present at the upstream end 300A of the system 300, the gas bubbles of that species will pass over the biofilm 316 surface. If the positive electrode is placed at this location, then chlorine microbubbles are formed, which was found to be very effective. However, the choice of placing the positive electrode at the upstream end 300A or the downstream end 300B of the system 300 primary depends on the application.

For instance, in RO filtration, it is known that the used membranes cannot tolerate a chlorine load, and as such the aromatic polyamide membranes lose their performance after 1,000 ppm/h of chlorine exposure. Therefore, for this application, the negative electrode, i.e., the hydrogen producing electrode should be placed at the upstream end 300A of the system to control biofouling. Similarly, for the NF, UF, MF pretreatment, where the biofouling is more prevalent, the membrane structures are stable when exposed to chlorine, and thus, the chlorine producing electrode (i.e., the positive electrode) can be effectively used at the upstream end 300A of the system 300.

When the electrical field E (which now extends parallel to the membrane, and not perpendicular) is applied in this configuration, between the first and second electrodes 320 and 330, it was observed that 99% of the biofilm 316 was eliminated from the membrane 310's surface. The microorganisms 318 were dispersed and the EPS (which ensure the mechanical stability of the biofilm and protects the embedded microbial communities) was decomposed, resulting in an instant uprooting of the biofilm upon exertion of the fluid shear, as illustrated in FIG. 3.

This almost instant cleaning of the biofilm from the membrane surface in this configuration is believed to be due to three factors: (a) the applied electrical current, (b) the direct chemical interaction between the generated gas (CI or H) with the biofilm, and (c) the mechanical disruption of the biofilm by the shear force created by the gas bubbles. The electrical current is known to electrocute the bacterial suspension, by rupturing the cell membrane. The active chlorine content in the saline water has a lethal impact on the microorganisms [3] and also causes a reduction in the EPS production as well as in the biofilm adhesion rate on surfaces. In addition, the shear force produced by the flowing bubbles 332 and/or 334 over and around the biofilm 316 further weakens the biomass and results in a very effective cleaning of the membrane surface.

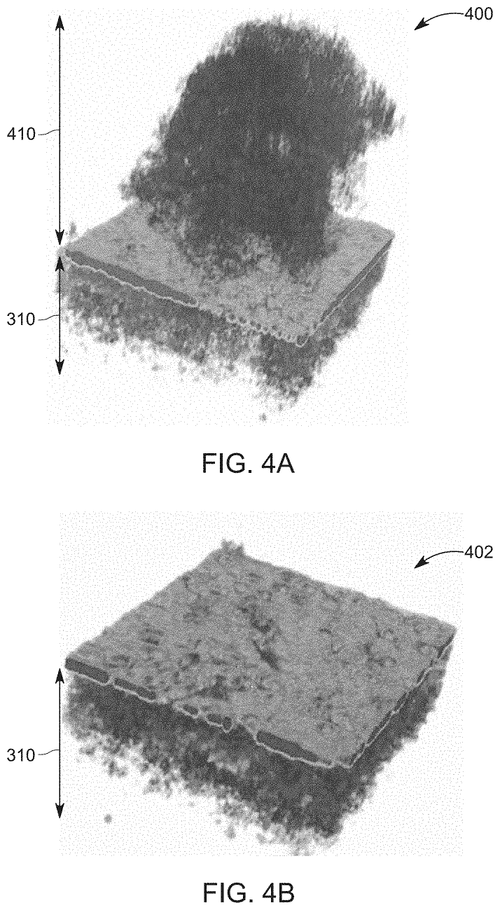

The above discussed biofouling/biofilm treatment technology has been proven to be very effective by conducting experiments at lab-scale in a membrane filtration system using a feed spacer. As shown in FIG. 4A (which is a three-dimensional optical coherence tomography (OCT) image), a membrane 310 was contaminated by using a synthetic solution composed of bacteria pre-grown in a seawater medium. After 10 days of filtration evolvement, when a biofouling cake 410 layer was formed on the membrane surface, an electrical shock was in-situ applied at 0.12 A for a length time of 90 sec through the use of platinum (Pt) electrodes, in a setup as illustrated in FIG. 3, followed by flushing the membrane at a flow rate of 500 mL/min for 30 sec. The cleaned membrane 310 is shown in FIG. 4B, which indicates that the biofouling cake 410 has been substantially removed.

The cleaning in the above filtration system was monitored by Optical Coherence Tomography (OCT) imaging. Three-dimensional OCT images were visualized before and after shocking the biofilm with electric field, as illustrated in FIGS. 4A and 4B. The obtained results confirmed that more than 99% of the biofouling developed on the filtration system was removed by the application of this technique.

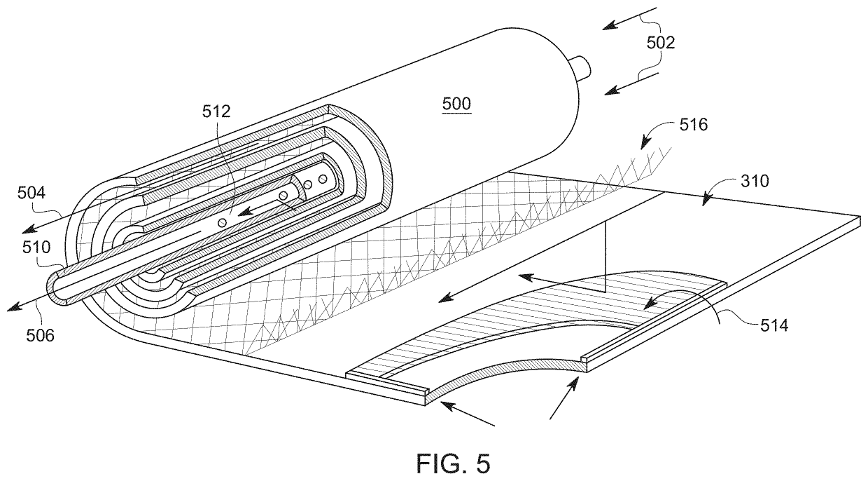

The proposed technology, which is schematically illustrated in FIG. 3, can be extended to any system in the water desalination industry. In most applications (e.g., MF, UF, NF, RO) spiral wound membrane modules are used. However, any type of membrane can be used. These spiral wound membrane modules include a stack of membranes, separated by feed and permeate spacers, and rolled over an inner perforated tube (to collect the permeate) to form a cylindrical module. Such a spiral wound membrane module 500 is shown in FIG. 5 and is configured to receive the feed 502 (e.g., seawater) at one end and to release at the other end the concentrate 504 and the permeate 506. The concentrate 504 (e.g., concentrated seawater) is the feed 502 from which the permeate 506 (e.g., freshwater) has been removed. The spiral wound membrane module 500 includes an inner pipe 510 that has plural perforations 512 through which the permeate is collected. Around the inner pipe 510, plural permeate carriers 514, membranes 310, and feed spacers 516 are wounded as indicated in the figure.

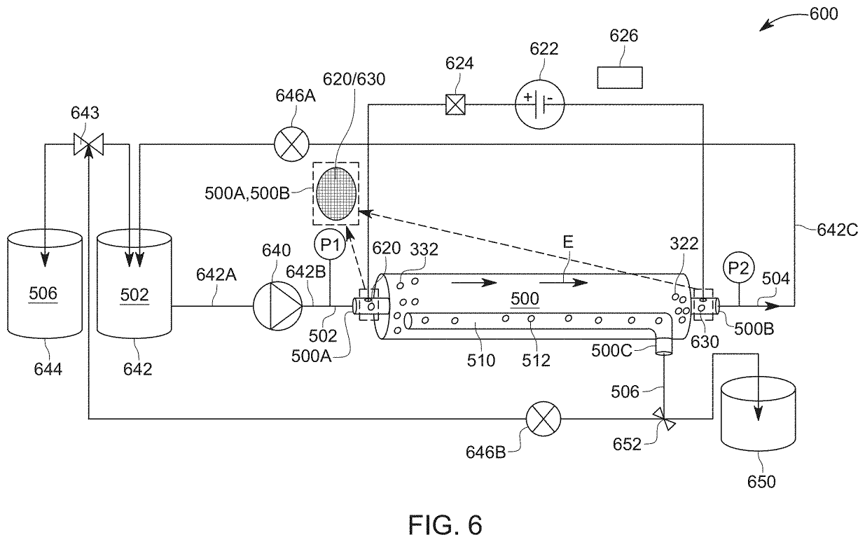

An industrial type filtration system that uses such a membrane module is now discussed with regard to FIG. 6. The filtration system 600 includes at least one spiral wounded membrane module 500. The module 500 has an inlet 500A for receiving the feed 502 and an outlet 500B for discarding the concentrate 504. The module 500 also has a permeate outlet 500C through which the permeate 506 exits the module. The inlet 500A is configured to hold a first electrode 620 (similar to the electrode 320 in FIG. 3) while the outlet 500B is configured to hold a second electrode 630 (similar to the electrode 330 in FIG. 3). In this embodiment, the first and second electrodes 620 and 630 are shaped as meshes. Other shapes may be used. The two electrodes 620 and 630 are placed inside the corresponding inlet/outlet 500A/500B so that they do not touch other mechanical parts of the system. The electrodes should not touch a conductive part of the system so that the applied electrical current can induce electrochemical reactions in the feed. However, if the applied current passes through the conductive part, the electrochemical reactions will not initiate and no biofouling removal will be achieved. Note that the two electrodes are configured to stay at all the time in the feed 502 and the concentrate 504, respectively, both of which are electrical conductive fluids. The two electrodes 620 and 630 are electrically connected to a power source 622. A switch 624 may be electrically connected to the leads of the electrodes 620 and 630 so that a control system 626, for example, situated in the control room of the plant, can reverse the polarities of the first and second electrodes, or can disconnect the power source from the first and second electrodes. The same process can be applied to any module, for example, plate and frame or hollow fiber modules.

A pump 640 is fluidly connected to a feed tank 642, which is configured to hold the feed 502. The pump 640, which may be controlled by the control system 626, is configured to pump the feed 502 through the module 500 and a piping system 642A to 642C, back to the feed tank 642. The same pump, or an additional pump (not shown) may be used to pump the permeate 506 to a permeate tank 644. A valve 643 may be located along the piping system to allow the permeate 506 to be diverted to the feed tank 642, if necessary. One or more other valves 646A and 646B, also controlled by the control system 626, are used to control the flow of the feed, permeate, and the concentrate through the piping system and the filtration module. Optionally, a disinfectant tank 650 may be fluidly connected, through a valve 652, to the permeate outlet 500C. The disinfectant tank is configured to store a disinfectant that is occasionally sent through the membrane module, instead of the feed, for general cleaning process.

Pressure sensors P1 and P2 are located at the inlet 500A and outlet 500B, respectively, for measuring the pressure difference across the filtration module 500. These sensors may be connected to the control system 626 so that when a drop in pressure is noted between the input and output of the filtration module, which is due to the fouling of the membrane, a biofilm removal procedure may be initiated. Other sensors may be located throughout the system for measuring other parameters, like temperature, salinity, electrical conductivity, etc.

The first and second electrodes 620 and 630 may be formed, as discussed above, as meshes. This shape is recommended at an industrial scale in order to trigger several pathways for the gas production 332, upstream of the filtration module 500. Also, the mesh shape generates a larger current density for the electrolysis process, which enables to handle a large volume of the incoming feed 502. The metal electrodes 620 and 630 (e.g., platinum, graphite, gold) should be chemically stable (e.g., inert) to prevent their involvement in the DEST process and also to restrict the formation of by-products.

Further, the application of the electric field E between the two electrodes, through the feed 502 and inside the filtration module 500, can be directly controlled from the control system 626. In one application, the control system 626 is configured to intermittently apply the electric field E, which has been observed to mitigate or delay biofouling appearing inside the filtration module 500. This will not only help in minimizing the pressure drop built-up in the plant operation, but will also maintain the permeate flux and the overall efficiency of the plant. For example, the control system is configured to switch on the power source when a pressure difference along the filtration module falls below a given threshold. In one application, the threshold is associated with a pressure difference falling 25% or more below the original pressure difference between the upstream and downstream points in the feed/concentrate. Other values may be used.

In one embodiment, the control system may be configured to activate the switch 624 to switch the polarity of the current, i.e., the first electrode is positively biased for a first time interval and then the same first electrode is negatively biased for a second time interval, where the first and second time intervals may be the same or different, and the first and second time intervals are less than 10 minutes, or less than 2 minutes. In one application, the two time intervals are in the orders of seconds, i.e., less than a minute each.

In still another embodiment, the first and second electrodes 620 and 630 are part of the filtration module 500. In this embodiment, the two electrodes are placed at the feed inlet and at the concentrate outlet so that when operational, the two electrodes are in direct contact with the feed and the concentrate, but not with the permeate. In one application, the first and second electrodes are never in contact with the permeate. The first and second electrodes are configured to hang freely in the inlet and outlet, respectively, of the filtration module. This means that the current or electric field applied between the first and second electrodes enters or ends directly in the feed/permeate and not a separator or other physical part of the filtration module.

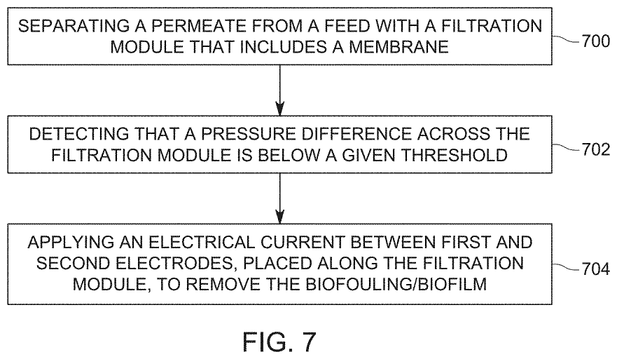

A method for removing biofouling/biofilm from a membrane is now discussed with regard to FIG. 7. The method includes a step 700 of separating a permeate 506 from a feed 502 with a filtration module 500 that includes a membrane 312, a step 702 of detecting that a pressure difference across the filtration module 500 is above a given threshold, and a step 704 of applying an electrical current between first and second electrodes 620, 630, which are placed along the filtration module 500, to remove the biofouling 316. The electrochemical reactions generated between the first and second electrodes 620, 630 are isolated in the feed side and do not influence the permeate quality. In addition, the method may include a step of positively biasing an upstream electrode to form Cl microbubbles, a step of reversing the polarity of the first and second electrodes, and/or a step of intermittently energizing the first and second electrodes, for a period of time in the order of seconds to minutes.

This proposed novel technique has one or more industrial advantages. This approach aids in smooth cleaning operations without halting the filtration process or the treatment plant. The cleaning can be controlled automatically from the control system without involvement of any special equipment, chemicals or manpower. This technology also performs cleaning in a very short time scale (from seconds to a few minutes) as opposed to the conventional Cleaning-In-Place (CIP) technique. In addition, this Direct Electrical Shock Technology offers an environmentally friendly, rapid and effective way to clean membrane modules, significantly reducing the cost and simplifying the biofilm control operation procedure. Lastly, this technique can be implemented not only in the new filtration modules, but also in the existing filtration plants.

The disclosed embodiments provide a biofouling removal system that is capable to remove a biofilm from a filtration membrane by application of electrical current inside the feed channel. It should be understood that this description is not intended to limit the invention. On the contrary, the embodiments are intended to cover alternatives, modifications and equivalents, which are included in the spirit and scope of the invention as defined by the appended claims. Further, in the detailed description of the embodiments, numerous specific details are set forth in order to provide a comprehensive understanding of the claimed invention. However, one skilled in the art would understand that various embodiments may be practiced without such specific details.

Although the features and elements of the present embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

### REFERENCES

[1] Zumbusch, P. v.; Kulcke, W.; Brunner, G., Use of alternating electrical fields as anti-fouling strategy in ultrafiltration of biological suspensions—Introduction of a new experimental procedure for crossflow filtration. Journal of Membrane Science 1998, 142 (1), 75-86.
[2] Brunner, G.; Okoro, E., Reduction of Membrane Fouling by Means of an Electric Field During Ultrafiltration of Protein Solutions. Berichte der Bunsengesellschaft für physikalische Chemie 1989, 93 (9), 1026-1032.
[3]Hülsheger, H.; Niemann, E.-G., Lethal effects of high-voltage pulses on E. coli K12. Radiation and Environmental Biophysics 1980, 18 (4), 281-288.
[4] Jagannadh, S. N.; Muralidhara, H. S., Electrokinetics Methods To Control Membrane Fouling. Industrial & Engineering Chemistry Research 1996, 35 (4), 1133-1140.
[5] Tarazaga, C. C.; Campderrós, M. E.; Padilla, A. P., Physical cleaning by means of electric field in the ultrafiltration of a biological solution. Journal of Membrane Science 2006, 278 (1), 219-224.

1. A biofouling removal system comprising:
a filtration module configured to separate a permeate from a feed;
a first inert electrode placed at an inlet of the filtration module;
a second inert electrode placed at an outlet of the filtration module; and
a power source configured to apply a current between the first and second electrodes,
wherein the inlet is configured to receive the feed and the outlet is configured to discard a concentrate, and
wherein the current applied between the first and second electrodes initiates electrochemical reactions inside the feed and along a biofilm formed in the filtration module, but not into the permeate.

2. The system of claim 1, wherein the first electrode is positively biased and the feed is saline water so that an electrolysis reaction that takes place when the first electrode is positively biased generates chlorine gas bubbles at the inlet of the filtration module.

3. The system of claim 1, wherein neither of the first and second electrodes is in direct contact with the filtration module.

4. The system of claim 3, wherein the filtration module is a spiral wound membrane module that includes a membrane, a feed spacer and the biofilm is formed on a surface of the membrane.

5. The system of claim 4, wherein the current flows only in the feed, on a feed side of the membrane.

6. The system of claim 1, wherein the feed is seawater and the permeate is fresh water.

7. The system of claim 1, wherein the first and second electrodes are shaped as meshes.

8. The system of claim 6, wherein the first electrode is fully immersed in the feed and the second electrode is fully immersed in the concentrate.

9. The system of claim 1, wherein neither of the first and second electrodes is in contact with the permeate.

10. The system of claim 1, wherein the current is a direct current having a value less than 1 Å.

11. The system of claim 1, further comprising:
a control system configured to switch on and off the power source.

12. The system of claim 11, wherein the control system is configured to switch on the power source when a sensed pressure difference along the filtration module rises above a given threshold.

13. A filtration module configured to separate a permeate from a feed to generate a concentrate, the filtration module comprising:
a membrane that separates the permeate from the feed;
an inlet configured to receive the feed;
an outlet configured to discharge the concentrate;
a permeate outlet configured to release the permeate;
a first electrode placed at the inlet of the filtration module; and
a second electrode placed at the outlet of the filtration module,
wherein a current is applied between the first and second electrodes in the feed and concentrate, but not in the permeate.

14. The filtration module of claim 13, wherein the current is applied in the feed side where a biofilm is formed on the membrane.

15. The filtration module of claim 13, wherein the first electrode is positively biased and the feed is seawater so that an electrolysis reaction that takes place when the first electrode is positively biased generates chlorine gas bubbles at the inlet of the filtration module.

16. The filtration module of claim 13, wherein the filtration module is a spiral wound membrane module that includes the membrane and the biofilm is formed on a surface of the membrane.

17. The filtration module of claim 13, wherein the first and second electrodes are shaped as meshes.

18. The filtration module of claim 13, wherein the first electrode is fully immersed in the feed and the second electrode is fully immersed in the concentrate.

19. The filtration module of claim 13, wherein neither of the first and second electrodes is in direct contact with the permeate.

20. A method for removing biofouling from a membrane, the method comprising:
separating a permeate from a feed with a filtration module that includes a membrane;
sensing that a pressure difference across the filtration module is above a given threshold; and
applying an electrical current between first and second electrodes, placed along the filtration module, to control the biofouling,
wherein the electrical current is applied between the first and second electrodes in the feed and a subsequent concentrate, but not in the permeate.
